(19) United States
(12) Patent Application Publication
(10) Pub. No.: US 2005/0076884 A1
(43) Pub. Date: Apr. 14, 2005

(54) Rotary internal-combustion engine

(76) Inventor: Marcello Zanetti, Modena (IT)

Correspondence Address: MODIANO & ASSOCIATI, Via Meravigli, 16, MILANO, 20123, IT

(21) Appl. No.: 10/945,976

(22) Filed: Sep. 22, 2004

(30) Foreign Application Priority Data
Oct. 9, 2003 (IT) MO2003A000275

(51) Int. Cl. F02B 53/00

(52) U.S. Cl. 123/241

(57) ABSTRACT

A rotary internal-combustion engine, comprising at least one fixed hollow body, and a movable body rotatable coaxially inside the fixed body, a chamber for a working fluid formed between the cylindrical bodies, at least one intake and at least one exhaust, at least one vane element associated with the outer surface of the movable body and extended in axial direction, at least one first and second partitions for dividing the chamber, the vane element, cooperating respectively with the intake to aspirate working fluid into the chamber, with the second partition to compress it, with the first partition to form a combustion chamber, and with the exhaust for working fluid expelling.

The present invention relates to a rotary internal-combustion engine for mobile and fixed or stationary applications.

### BACKGROUND OF THE INVENTION

Internal-combustion engines are known in which the conversion of the working fluid into energy occurs according to known cycles: the Otto cycle in spark-ignition engines, and the Diesel cycle in compression-ignition engines, and each cycle comprises the strokes of intake, compression, power and exhaust.

A first type of these machines provides for the reciprocating rectilinear motion of a piston inside a hollow cylinder, which is subsequently converted into a rotary motion by means of an ordinary crank system (connecting rod/crank system).

In particular, one side of the piston is placed in contact with the working fluid, which accesses the cylinder through induction and exhaust valves and/or ports.

The opposite side is instead connected to the engine shaft by means of the connecting rod, the small end of which is pivoted to the pin of the piston and the big end of which is coupled to the crank pivot of the engine shaft; the small end moves with a reciprocating rectilinear motion together with the piston, while the big end traces a circle whose radius is equal to the half the stroke of the piston, i.e., equal to the crank radius.

In reciprocating internal-combustion engines, the fluid-dynamic operating cycle is completed in four successive strokes of the piston, which occur every two turns of the engine shaft (four-stroke engine), or in just two strokes, which correspond to one turn of the engine shaft (two-stroke engine).

Considering schematically, in particular, the operation of a conventional four-stroke engine, the first 180° of the rotation of the engine shaft (first stroke of the piston) correspond to the intake stroke, during which the working fluid is introduced in the cycle; the second 180° (second stroke of the piston), which complete the first turn, correspond to the stroke for compression of the fluid while the intake and exhaust valves are closed; the next 180° (third stroke of the piston) correspond to the useful power stroke of combustion and expansion, which occurs while the valves are closed; and finally, the last 180° (fourth stroke of the piston), which complete the second turn of the engine shaft, correspond to the exhaust stroke, during which the products of combustion are discharged externally while the exhaust valve is open.

Reciprocating internal-combustion engines are not free from drawbacks, including the fact that they do not allow to achieve high values of efficiency and overall performance, in addition to being scarcely elastic in operation and to having a power delivery that is not always regular.

In particular, it is stressed that during expansion the working fluid reaches the maximum pressure when the connecting rod and the crank are still substantially aligned; in this configuration, the torque transmitted to the engine shaft is greatly penalized by a very small value of the lever arm of the force discharged onto the crank.

When instead the lever arm of the force is greatest (connecting rod and crank arranged at right angles), the pressure and therefore the transmitted force are reduced significantly.

Moreover, one should not forget that the piston of a reciprocating engine is subjected to extremely intense stresses, since at each reversal of motion it is forced to decelerate until it stops and then accelerate in the opposite direction; this of course entails a considerable reduction in overall efficiency due to vibrations, friction and inertia effects, which increase in proportion to the imbalance of the masses of the engine.

Moreover, reciprocating engines require complex and expensive design and assembly steps, since they require means for converting the motion from reciprocating to rotary: in particular, it is noted that the connecting rod, which is articulated with respect to the piston and the crank, requires accurate sizing both in terms of flexing and in terms of instability (combined bending and compressive stress).

A second type of internal-combustion engine is constituted by rotary engines, in which the elements that collect the mechanical work provided by the working fluid have a rotary motion: these engines include the so-called Wankel engine, which takes its name from its inventor.

This engine comprises a prism-like rotor, which has an equilateral triangular base with slightly convex sides; the rotor is contained within a housing, or stator, in which the ports for aspirating the air-fuel mix and for discharging the burnt gases are provided, and is closed at its axial ends by two end faces, each of which is provided with a hole for the passage of the engine shaft.

A gear with inward teeth (rotor ring gear) is keyed at the center of the rotor and meshes with a gear with outward teeth, which is rigidly coupled to the housing (stator pinion) and is coaxial to the main journals of the engine shaft.

The orbital motion of the rotor about the pinion is transmitted externally by means of an eccentric element that is keyed to the engine shaft.

The cross-section of the internal cavity of the stator forms a curve that resembles a flattened ellipse and is more precisely termed two-lobed epitrochoid; in normal operation of the engine, this curve is traced by the three apex ends of the rotor, which are provided with sealing gaskets.

By rotating inside the housing, in particular, the rotor forms three chambers for containing the working fluid; the volume of said chambers varies cyclically, and three four-stroke Otto cycles, offset at 120° to each other, are performed simultaneously in said chambers: the combustion process therefore occurs sequentially three times in each turn of the rotor, which corresponds to three turns of the engine shaft.

The Wankel engine, too, has drawbacks: it is in fact affected by high fuel consumption due to incomplete combustion of the air-gasoline mix.

As a collateral but certainly not negligible effect of an imperfect combustion, the Wankel engine also has a high level of noxious emissions, particularly unburnt hydrocarbons, which causes it to pollute excessively and severely restricts its applications. Moreover, it is noted that this internal-combustion engine, too, is particularly complicated and expensive, since it does not ensure the long life of some of its essential components, particularly the sealing gaskets and the lining of the stator chamber.

The field of the use of the Wankel engine, finally, is considerably restricted, making it scarcely suitable for applications that require great elasticity and the flattest possible torque and power curves.

### SUMMARY OF THE INVENTION

The aim of the present invention is to eliminate the drawbacks noted above of known types of internal-combustion engine, by providing a rotary engine that allows to achieve a high performance in terms of efficiency, to reduce the complexity of the elements for transmitting power from the combustion chamber to the output of the engine shaft, and to reduce significantly the imbalances of the masses, and is further particularly lightweight and compact.

Within this aim, an object of the present invention is to be particularly elastic in operation and to be able to provide excellent power performance both at low and high rpm rates in addition to being simple to tune.

Another object of the present invention is to provide an engine that has limited consumption and low levels of noxious emissions.

Another object of the present invention is to simplify considerably the cooling of the components, which can be achieved by coupling a conventional air cooling system to the engine.

Another object of the present invention is to contain manufacturing costs and to be at the same time particularly reliable and durable thanks to a reduced degree of wear.

Another object of the present invention is to provide an engine that is simple, relatively easy to provide in practice, safe in use, effective in operation, and has a relatively low cost.

This aim and these and other objects that will become better apparent hereinafter are achieved by the present rotary internal-combustion engine, characterized in that it comprises at least two cylindrical bodies, one of said bodies being fixed and hollow, the other body being movable and supported so that it rotates coaxially inside the other body and being associated with an engine output shaft, a chamber for the evolution of a working fluid being formed between said cylindrical bodies, at least one intake and at least one exhaust for the working fluid provided on said fixed cylindrical body, at least one vane element that is associated with the outer surface of said movable cylindrical body and is substantially extended in an axial direction, at least one first partition and at least one second partition for dividing said chamber, said vane element, by rotating, being suitable to cooperate respectively with said intake in order to aspirate the working fluid into said chamber, with said second partition in order to compress the working fluid in said chamber, with said first partition in order to form a chamber for the combustion of the working fluid, and with said exhaust in order to expel the working fluid from said chamber.

### BRIEF DESCRIPTION OF THE DRAWINGS

Further characteristics and advantages of the present invention will become better apparent from the following detailed description of a preferred but not exclusive embodiment of a rotary internal-combustion engine, illustrated by way of non-limiting example in the accompanying drawings, wherein:

FIG. 1 is a schematic and partial transverse sectional view of a first embodiment of the engine according to the invention;

FIG. 2 is a schematic and partial transverse sectional view of a second embodiment of the engine according to the invention;

FIGS. 3 to 6 are successive reduced-scale views of the operation of the engine of FIG. 1;

FIGS. 7 to 14 are successive reduced-scale views of a first type of operation of the engine of FIG. 2;

FIGS. 15 to 20 are successive reduced-scale views of a second type of operation of the engine of FIG. 2.

### DESCRIPTION OF THE PREFERRED EMBODIMENTS

With reference to the figures, the reference numeral 1 generally designates a rotary internal-combustion engine, which comprises two hollow cylindrical bodies: a first, fixed body 2, being connected to a supporting frame, and a second, movable body 3, which is rigidly and coaxially associated with an engine output shaft; the supporting frame and the engine shaft are not shown, since they are of a conventional type.

The movable cylindrical body 3 is supported so that it can rotate and is coaxial inside the fixed cylindrical body 2.

The outside diameter of the movable cylindrical body 3 is smaller than the inside diameter of the fixed cylindrical body 2; a chamber 4 for the evolution of a working fluid F is in fact provided between them.

Said chamber is closed at its axial ends; in particular, there are two faces for closing said ends, which are associated with the fixed cylindrical body 2 by way of screws and can be removed from it in order to allow the assembly and disassembly of the engine 1; said faces are of a conventional type and are not shown.

The fluid F is flammable and in fact comprises a comburent gas, such as for example air A, and a combustible gas; following combustion, said fluid can evolve, forming combustion products P.

The engine 1 is provided with an intake 5 and with an exhaust 6 for the fluid F, which are formed in the fixed cylindrical body 2 and connect the chamber 4 to the outside environment by way of respective intake and exhaust ducts of a conventional type, which are not shown.

The present invention further comprises a vane element 7, which is associated with the outer surface of the movable cylindrical body 3, with respect to which it is arranged axially along the entire length of the chamber 4.

The radial and axial dimensions of the vane element 7 are respectively equal to the radial and axial dimensions of the chamber 4, so that said element can rotate snugly within said chamber together with the movable cylindrical body 3 with which it is associated; its transverse cross-section, moreover, is substantially quadrilateral, with sides adjacent to the chamber 4 which, with respect to the radial direction, i.e. with respect to a corresponding radius of the bodies 2, 3 that passes therethrough, are inclined forward in the direction of rotation of the movable cylindrical body 3.

A first partition 8a and a second partition 8b for dividing the chamber 4 are also provided and are as long as the axial extension of said chamber and can be inserted snugly respectively through a first slot 9a and a second slot 9b, which are formed in the fixed cylindrical body 2 along the axial direction.

The two slots 9a and 9b are arranged substantially adjacent and in particular are offset by approximately 30° of rotation about the axis of the cylindrical bodies 2 and 3.

A plurality of splined profiles 10 are interposed between these slots and are formed on the fixed cylindrical body 2; in greater detail, said profiles are elongated tangentially with respect to the cylindrical bodies 2 and 3, with an extension that is slightly shorter than the distance between the two slots 9a and 9b.

According to the invention, the vane element 7, by-rotating together with the movable cylindrical body 3, is suitable to cooperate respectively with the intake 5 to aspirate the fluid F into the chamber 4, with the second partition 8b to compress the fluid F in the chamber 4, with the first partition 8a to form a combustion chamber for the fluid F, and with the exhaust 6 to expel said fluid from the chamber 4.

The ignition of the fluid F inside the combustion chamber can be spontaneous by compression, or spark-controlled, depending on the type of combustible gas used.

In the embodiments of the present invention illustrated herein, the ignition of the fluid F is spark-controlled, since there are means 11 for igniting said fluid which comprise at least one high-voltage spark-plug or a glow plug, which are not shown since they are of a conventional type; however, alternative embodiments in which ignition is entrusted to the increase in pressure inside the chamber 4 are also possible.

Advantageously, the ignition means 11 are associated with the fixed cylindrical body 2 at the splined profiles 10, but alternative embodiments of the engine 1 are possible in which said ignition means are associated with the fixed cylindrical body 2 downstream of the second slot 9b with respect to the direction of rotation of the movable cylindrical body 3.

The engine 1 can be provided with a conventional cooling system, not shown in the figures, which allows to remove heat from the outer surface of the fixed cylindrical body 2 and from the inner surface of the movable cylindrical body 3; in particular, said surfaces can be provided with conventional metallic fins for air cooling or with internal ducts for liquid cooling.

In a first embodiment of the present invention, shown in FIG. 1, the engine 1 comprises a third partition 8c for dividing the chamber 4, which can also be inserted snugly through a third slot 9c formed axially in the fixed cylindrical body 2.

The third slot 9c is formed substantially in a diametrically opposite position with respect to the first and second slots 9a and 9b; in particular, it is offset by approximately 150° with respect to the first slot 9a and by approximately 180° with respect to the second slot 9b, but variations of these offsets that meet different operating requirements are also possible.

The engine 1 comprises means 12 for actuating the partitions 8a, 8b, 8c, by way of which said partitions can be inserted and removed from the chamber 4.

For each partition 8, said actuation means comprise a sort of rocker 13, which is substantially semicylindrical and rotates alternately about its own axis E, which is parallel to the axis O of the cylindrical bodies 2 and 3.

A respective partition is associated tangentially with the flat surface of each rocker 13, and its transverse cross-section, like the cross-section of the corresponding slot, is substantially curved.

The actuation means 12 further comprise rotating eccentric means of a known type, which are not shown, and are interposed between the engine output shaft and the rocker 13.

The constructive configuration of the rocker 13 and of the partitions 8 is to be considered particular and not exclusive, and alternative embodiments of the machine 1 are also possible in which, for example, the actuation means 12 have a gate-like mechanism with flat partitions 8.

The intake 5 and the exhaust 6, finally, are arranged substantially adjacent, with the third slot 9c interposed between them.

In this first embodiment of the present invention, the operating cycle of the fluid F is completed at each revolution of the engine output shaft.

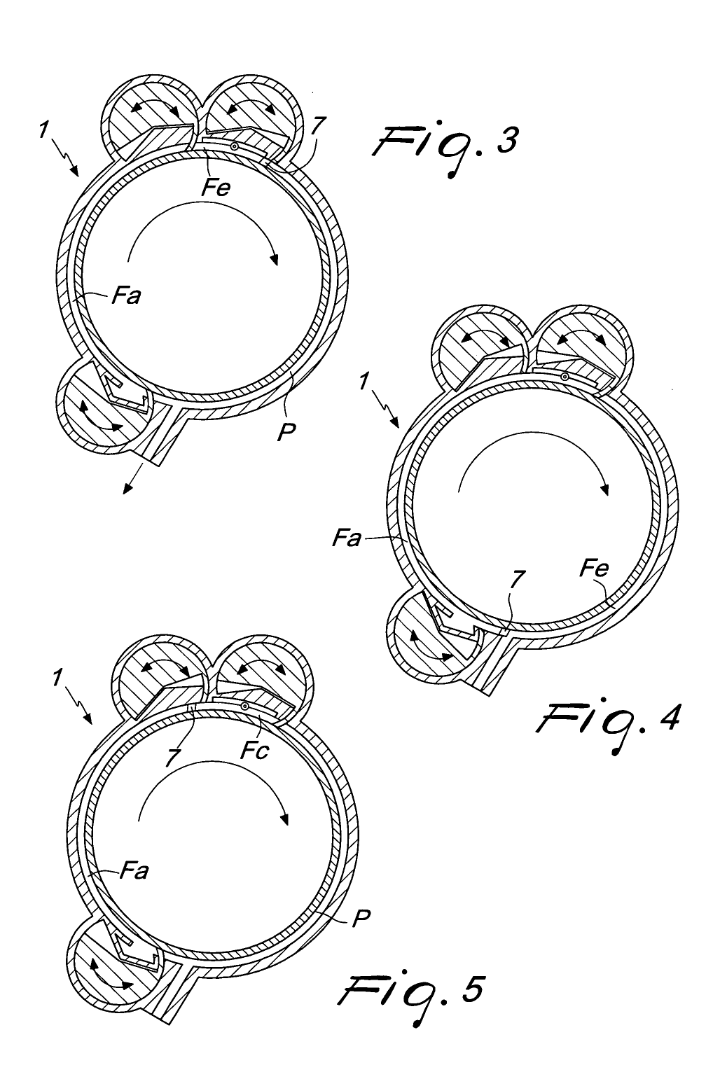

Upon activation of the ignition means 11 (FIG. 3), the vane element 7 is arranged at the second partition 8b, which is not inserted in the chamber 4; the first partition 8a and the third partition 8c instead are in the insertion position.

In the portion of chamber 4 that is comprised between the vane element 7 and the first partition 8a there is the working fluid, designated by the reference sign Fe in the figures, which by burning expands.

The portion of the chamber 4 that is comprised between the vane element 7 and the third partition 8c is instead occupied by the products P of combustion of the preceding cycle.

The portion of the chamber 4 that is comprised between the first partition 8a and the third partition 8c is also occupied by the fluid previously aspirated through the intake 5 and designated by Fa.

As a consequence of the expansion of the fluid produced by the high pressures reached during combustion, the vane element 7, together with the movable cylindrical body 3 rigidly coupled thereto, is propelled so as to rotate, also allowing expulsion of the products P through the exhaust 6.

This expansion ends when the vane element 7 reaches the exhaust 6, when the opening of the third partition 8c is actuated promptly (FIG. 4), followed by its reinsertion as soon as said vane element has moved beyond it.

From this moment, compression of the previously aspirated fluid Fa begins, and at the same time the introduction of the working fluid that will be processed in the next turn through the intake 5 also begins.

The compressed fluid, designated by Fc, increases its pressure (FIG. 5) until the vane element 7 reaches the splined profiled elements 10, when the first partition 8a is inserted.

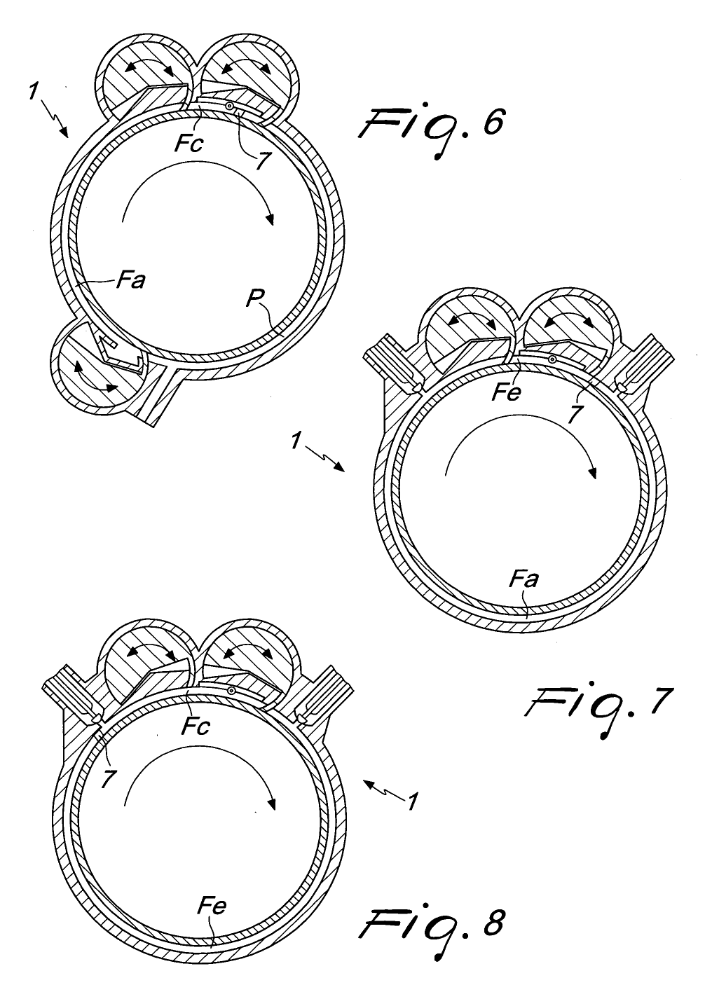

By keeping the compressed fluid Fc enclosed between the first partition 8a and the second partition 8b, it is in fact possible to transfer the vane element 7 to the second partition 8b (FIG. 6), where a new combustion cycle can be started.

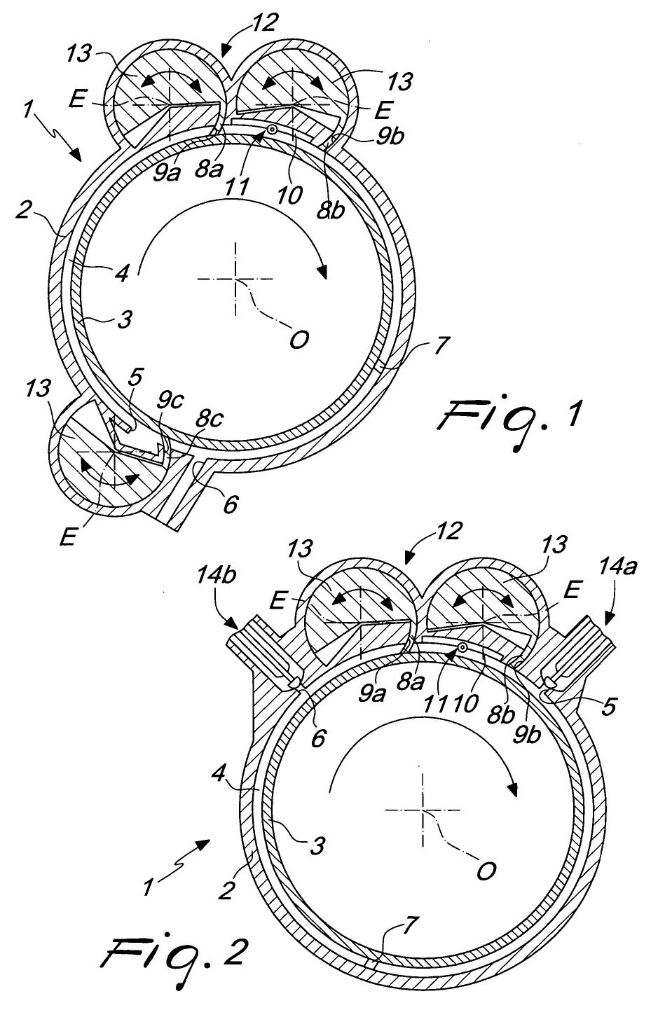

In a second embodiment of the present invention, shown in FIG. 2, the engine 1 comprises first valve means 14a and second valve means 14b, which are suitable to adjust the flow respectively through the intake 5 and the exhaust 6.

The closure and opening of said valve means, in particular, can be actuated by way of activation means of a known type, which are not shown, such as mechanisms with cams, eccentric elements and the like, which are interposed between said valve means and the engine output shaft.

The intake 5 is formed in the fixed cylindrical body 2 adjacent to the second slot 9b, on the opposite side with respect to the first slot 9a; the exhaust 6 is instead arranged adjacent to the first slot 9a, on the opposite side with respect to the second slot 9b.

As regards the actuation means 12, finally, reference is made to what has already been described for the first embodiment of the present invention.

In this second embodiment of the machine 1, two different types of operation are possible: the first type, shown in FIGS. 7 to 14, completes two combustion cycles of the fluid F every four turns of the engine output shaft, while the second type, shown in FIGS. 15 to 20, has a single cycle every three turns of the output engine shaft.

According to the first type of operation, when the charge is ignited (FIG. 7), both valve means 14a, 14b are closed and the vane element 7 is arranged at the second partition 8b, which is not inserted in the chamber 4; the first partition 8a is instead in the insertion position.

Accordingly, the chamber 4 is divided into two portions: a smaller one, in which the expanding working fluid Fe is present, and a larger one, which is instead occupied by previously aspirated fluid Fa.

During the fluid expansion stroke, the vane element 7 is turned together with the movable cylindrical body 3 rigidly coupled thereto, at the same time allowing the compression of the aspirated fluid Fa (FIG. 8).

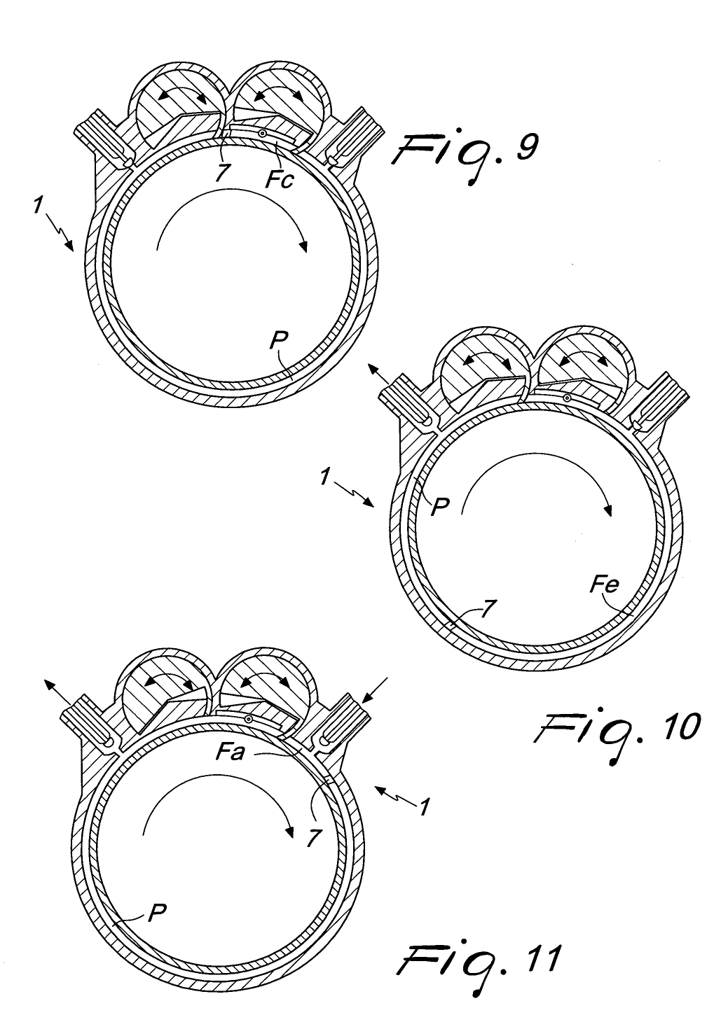

At the end of the first turn, when the vane element 7 reaches the splined profiles 10 (FIG. 9), the first partition 8a is inserted in the chamber 4, ending the expansion of the fluid, which by then has evolved onto combustion products P, and isolating between the two partitions a volume of compressed fluid Fc that is ready for a new combustion, which also begins with the activation of the ignition means 11.

The subsequent expansion stroke occurs while the second valve means 14b are open, so as to utilize the rotation of the movable cylindrical body 3 to expel from the chamber 4 the products P of the first combustion (FIG. 10).

Once the exhaust 6 has been reached by the vane element 7, the first partition 8a is extracted from the chamber 4 to allow its passage; at the beginning of the third turn, therefore, once the intake 5 has been reached, the second partition 8b is inserted and the first valve means 14a are opened, so as to allow the aspiration of fluid Fa.

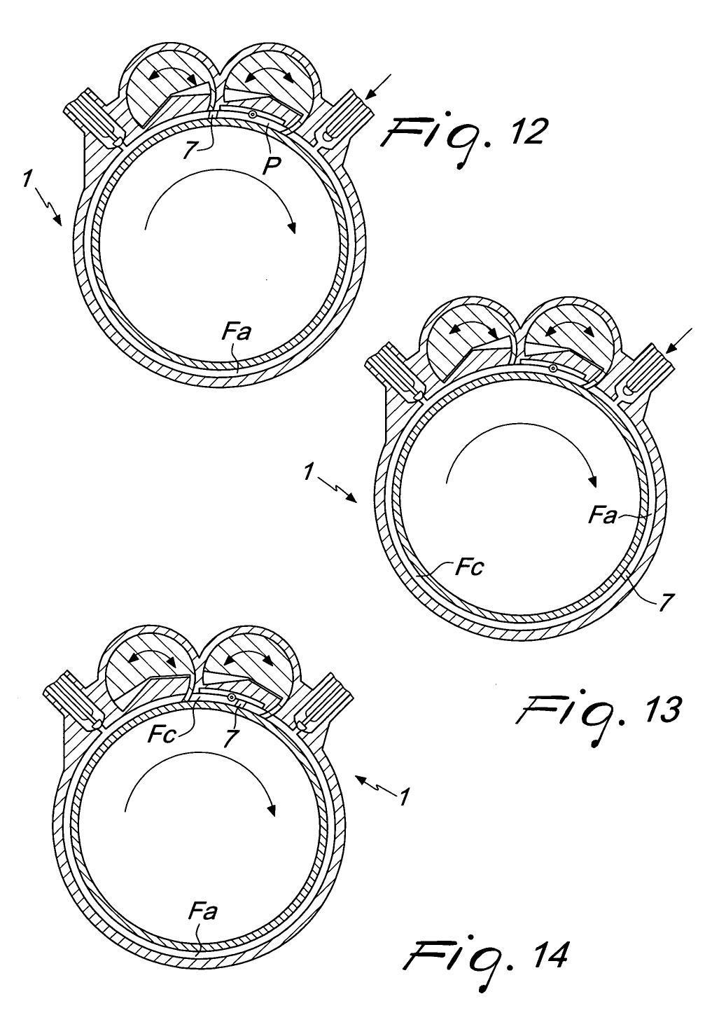

Simultaneously with this aspiration, the products P derived from the second combustion are discharged externally, since the second valve means 14b (FIG. 11) are still open and are closed only when the exhaust 6 is reached by the vane element 7 (FIG. 12).

At the beginning of the fourth turn, the second partition 8b is extracted from the chamber 4 in order to allow the passage of the vane element 7, and then is immediately reinserted behind it; during this last rotation, a new aspiration of fluid Fa through the intake 5 and a new compression of fluid Fc (FIG. 13) are performed simultaneously, and at the end of the fourth turn the fluid Fc is again isolated between the first partition 8a and the second partition 8b (FIG. 14).

The subsequent closure of the first valve means 14a and the activation of the ignition means 11 allow to start a new combustion cycle.

With reference instead to the second type of operation, when the charge is ignited (FIG. 15), the vane element 7 is arranged at the second partition 8b, which is not inserted in the chamber 4; the first partition 8a instead is in the insertion position.

The first and second valve means 14a, 14b are respectively in the closed position and in the open position.

The expanding working fluid Fe is in the portion of the chamber 4 that is comprised between the vane element 7 and the first partition 8a; the portion connected to the exhaust 6 is instead occupied by air A.

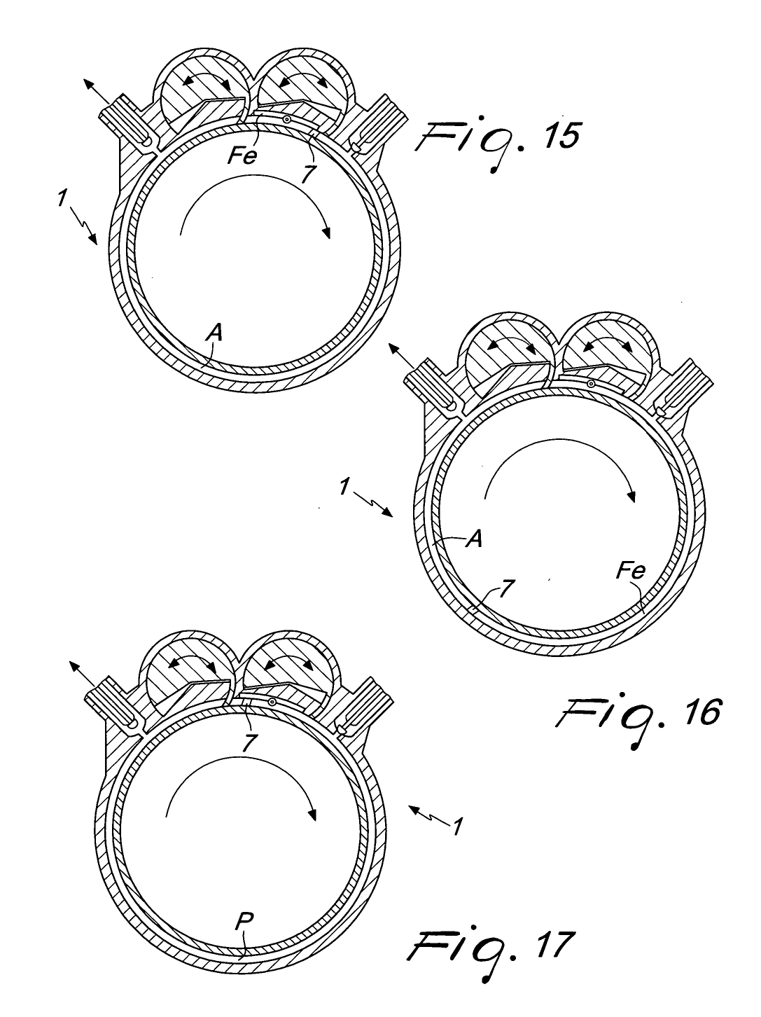

During the fluid expansion stroke, the vane element 7 is turned together with the movable cylindrical body 3 rigidly coupled thereto, allowing at the same time the expulsion of the air A through the exhaust 6 (FIG. 16).

At the end of the first turn, when the vane element 7 reaches the exhaust 6, the first partition 8a is extracted from the chamber 4 to allow the passage of the vane element 7, and is then reinserted behind it (FIG. 17).

From this point onward, the products P of combustion, which occupied the chamber 4 at the end of expansion, are expelled under the propelling action of the vane element 7.

At the same time, after the first valve means 14a have opened and the second partition 8b has been inserted (FIG. 18), the vane element 7 draws into the chamber 4 working fluid F that arrives from the intake 5.

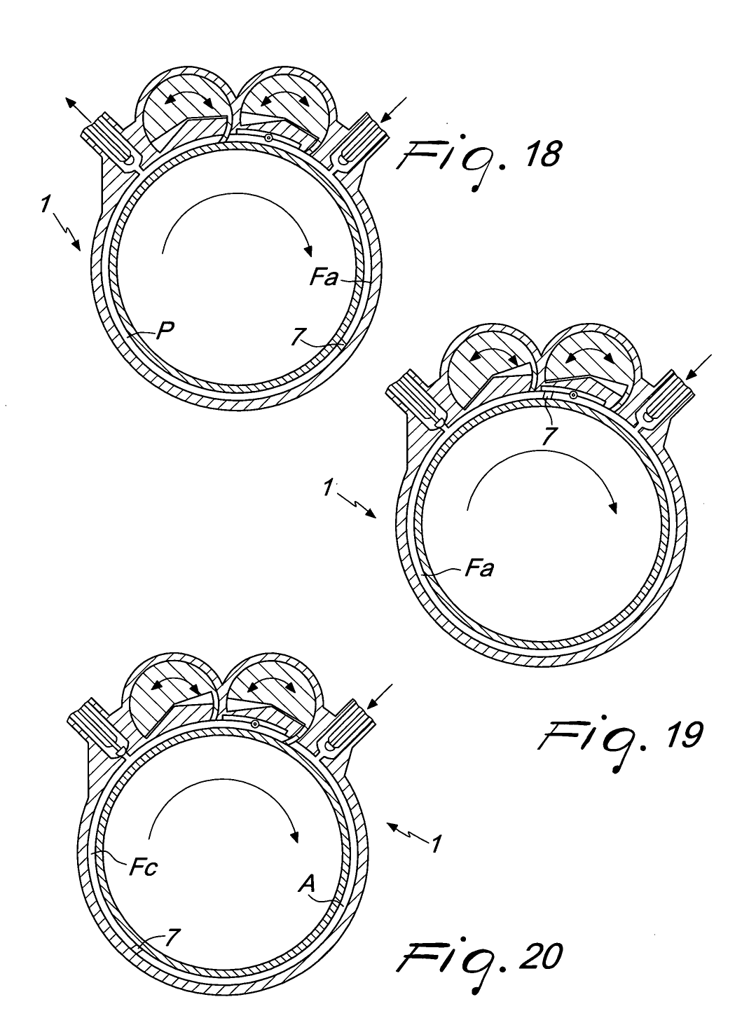

When the exhaust 6 is reached, the first partition 8a and the second partition 8b are extracted in order to allow the passage of the vane element 7 (FIG. 19); once it has passed beyond the intake 5, the second partition 8b is reinserted in the chamber 4.

At the last turn, therefore, the fluid aspirated in the preceding turn is compressed and at the same time air A is aspirated through the intake 5, which is still connected to the outside (FIG. 20). Finally, after passing beyond the exhaust 6, the second valve means 14b are opened, subsequently completing the compression of the fluid Fc until the initial configuration is reached.

In practice it has been found that the described invention achieves the intended aim and objects.

It is also noted that the present rotary internal-combustion engine allows to achieve excellent results in terms of absolute power simply by providing it with a larger number of vane elements, of partition sets, of input and output openings, thus being able to improve performance while limiting space occupation.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Patent Application No. MO2003A000275 from which this application claims priority are incorporated herein by reference.

1. A rotary internal-combustion engine, comprising: at least two cylindrical bodies of which a first one being fixed and hollow, and a second one being movable and supported so as to be coaxially rotatable inside the first body, said second movable body being associated with an engine output shaft; a chamber for a working fluid that is formed between said first and second cylindrical bodies; at least one fluid intake; at least one fluid exhaust; at least one vane element that is associated with an outer surface of said second movable cylindrical body, said vane element having a substantially axial extension on said outer surface; at least one first partition; and at least one second partition, said first and second partitions for dividing said chamber, and wherein said vane element is adapted, upon rotation of said second movable element, to cooperate, respectively, with said intake in order to aspirate the working fluid into said chamber, with said second partition in order to compress the working fluid in said chamber, with said first partition in order to form a combustion chamber for combustion of the working fluid, and with said exhaust in order to expel the working fluid from said chamber.

2. The engine of claim 1, wherein said chamber is closed at axial ends thereof.

3. The engine of claim 2, wherein said chamber has the axial ends thereof closed by faces associated with at least one of said first fixed cylindrical body and said second movable cylindrical body.

4. The engine of claim 1, comprising a first and a second slots, which are formed in said first fixed cylindrical body substantially along an axial direction thereof, said first and second partitions being insertable in said chamber respectively through said first and second slots.

5. The engine of claim 1, wherein said vane element is shaped with a radial extension substantially equal to a radial extension of said chamber.

6. The engine of claim 5, wherein said vane element is shaped with an axial extension substantially equal to an axial extension of said chamber.

7. The engine of claim 6, wherein said vane element is shaped with a transverse cross-section that is substantially quadrilateral, with sides thereof that are adjacent to said chamber being inclined with respect to a direction of a corresponding vadius of said first and second bodies.

8. The engine of claim 4, wherein said first and second slots are substantially adjacent, said fixed cylindrical body being provided internally with at least one splined profile that is substantially interposed therebetween.

9. The engine of claim 8, wherein said first fixed cylindrical body is provided with a plurality of said splined profiles, which are elongated in a tangential direction thereof.

10. The engine of claim 1, adapted for ignition of the working fluid that is spontaneous and produced by compression.

11. The engine of claim 9, adapted for ignition of the working fluid that is spark-controlled, and comprising ignition means for igniting the working fluid.

12. The engine of claim 11, wherein said ignition means comprises at least one high-voltage spark-plug.

13. The engine of claim 11, wherein said ignition means comprises at least one glow plug.

14. The engine of claim 11, wherein said ignition means are associated with said first fixed cylindrical body at said splined profiles.

15. The engine of claim 14, wherein said ignition means are associated with said first fixed cylindrical body downstream of said second slot with respect to a direction of rotation of said movable cylindrical body.

16. The engine of claim 4, comprising a third partition for dividing said chamber.

17. The engine of claim 16, wherein said third partition can be inserted through a respective third slot formed axially in said first fixed cylindrical body.

18. The engine of claim 17, wherein said intake and said exhaust are located substantially adjacent, with said third slot being interposed therebetween.

19. The engine of claim 18, wherein said third slot is formed in said first fixed cylindrical body substantially in a diametrically opposite position with respect to said first and second slots.

20. The engine of claim 19, further comprising actuation means for actuating said partitions.

21. The engine of claim 20, wherein said actuation means comprises a rocker that is associated with a respective one of said partitions and rotates alternately about a rocker axis that is parallel to an axis of said first and second cylindrical bodies.

22. The engine of claim 21, wherein said actuation means are provided with rotating eccentric means of a known type that are associated with said rocker.

23. The engine of claim 4, comprising first valve means that are adapted to adjust fluid flow through said intake.

24. The engine of claim 23, comprising second valve means adapted to adjust fluid flow through said exhaust.

25. The engine of claim 24, wherein said intake is formed in said first fixed cylindrical body substantially adjacent to said second slot, on an opposite side with respect to said first slot.

26. The engine of claim 25, wherein said exhaust is formed in said first fixed cylindrical body substantially adjacent to said first slot, on an opposite side with respect to said second slot.
